(19) United States
(12) Patent Application Publication
(10) Pub. No.: US 2018/0215849 A1
(43) Pub. Date: Aug. 2, 2018

(54) SEGMENT COPOLYMER FOR MAKING ICEPHOBIC COATINGS

(71) Applicant: AGENCY FOR SCIENCE, TECHNOLOGY AND RESEARCH, Singapore (SG)

(72) Inventors: Liang HONG, Singapore (SG); Siok Wei TAY, Singapore (SG); Yeap Hung NG, Singapore (SG)

(21) Appl. No.: 15/883,024

(22) Filed: Jan. 29, 2018

(30) Foreign Application Priority Data
Jan. 27, 2017 (SG) 10201700732W

(51) Int. Cl. C08F 220/18; C08F 220/06; C08F 14/06; C08F 12/08; C08K 5/01; C08K 5/00; C08L 23/06; C08L 55/02; C09K 3/18

(52) U.S. Cl. CPC C08F 220/18; C08F 220/06; C08F 14/06; C08F 12/08; C08K 5/01; C08F 2220/325; C08L 23/06; C08L 55/02; C09K 3/18; C08F 2220/1883; C08K 5/0025

(57) ABSTRACT

This invention relates to segment copolymer comprising rigid and soft segments wherein the soft segments are doped with a wax. A model polymer of this new type can be synthesized by the free radical copolymerization of methyl methacrylate (MMA) (39 wt %), lauryl, methacrylate (LMA) (10 wt %) and an adduct monomer of glycidyl methacrylate (GMA) and 1-dodecylamine (DDA). Doping with paraffin wax is one suitable approach to obtain the inventive material. The invention further relates to a simple and low-cost process to make these polymers and coatings comprising the polymers. Using the polymer material a coating with a highly icephobic surface can be obtained comprising soft hydrophobic micro domains segregated and stabilized by rigid copolymer on its surface. The icephobic behaviour may find new application in aerospace applications.

### CLAIM OF PRIORITY

This application claims the benefit of priority of Singapore Patent Application No. 10201700732W, filed on Jan. 27, 2017, the benefit of priority is claimed hereby, and which is incorporated by reference herein in its entirety.

### TECHNICAL FIELD

The present invention generally relates to a segment copolymer comprising rigid and soft segments wherein the soft segments are doped with a wax. The polymer can be used to make an icephobic coating of which the icephobic performance arises from segregated soft hydrophobic microdomains spreading over the coating surface. This surface heterogeneity is realized through incorporating a small dose of paraffin wax into a micro-polymer matrix formed of a specific type of segment copolymers with the chains consisting of rigid and soft hydrophobic segments. The wax molecules selectively dope the soft hydrophobic segments owing to the structural similarity between aliphatic side chains and paraffin hydrocarbon chains, which enhances micron-scaled segregation between rigid and soft hydrophobic segments. The segregated soft hydrophobic microdomains sustain supercooled water droplets through the dynamic alternations of a huge number of conformations of soft aliphatic chains, from which entropy is transferred to the water phase. This hydrophobic agitation at interface retards icing surrounding them and leads to a significant delay of icing as well as a reduction in ice adhesion eventually.

### BACKGROUND ART

Thermal hot air bleed anti-icing systems and the installation of rubber de-icing boots have been used in the aviation industry to remove ice accumulated on the leading edges of wings and control surfaces (e.g. horizontal and vertical stabilizer) of aircrafts. Recently, several different methods using electrothermal or electromagnetic devices were proposed. Although hot air bleeds from engines to evaporate the impinging supercooled water droplets on the leading edge surface is highly efficient and maneuverable for anti-icing, problems such as the related energy consumption and the vulnerability of composite materials to heat erosion are present at the same time. Alternatively, adoption of electromagnetic and chemical dissolution methods that break ice accretion on the leading parts also raise concerns with regard to the damage of the skin materials since the device exerts an impulsive force or chemicals on the surface. There is currently no icephobic surface treatment capable of tendering robust performance on high performance aerodynamic surfaces; furthermore, most concepts are not affordable or not easily repairable. In contrast to the approaches utilizing fusion, scraping and dissolution to remove ice, the endeavor to fabricate an intrinsically icephobic surface is obviously more attractive because of low cost and convenience. To date, two typical icephobic surface structures have been identified: (i) Traditionally superhydrophobic surface consisting of low-energy molecular chains such as perfluoro-carbon or long hydrocarbon chains and rough topography in micron and nano scales, known as lotus-leaf inspired superhydrophobic surfaces (LLISS); (ii) Slippery liquid-infused porous surfaces (SLIPS) comprising a porous substrate and a non-volatile lubricating liquid layer on the substrate. As icing starts with formation of frost in humid air, an icephobic surface should defer formation of frost, in particular a flat frost on it, and be able to induce weak ice texture near to the surface. Icephobic performance of a surface in question is often assessed in lab by the retardation of sessile droplet from freezing and the reduction of ice adhesion relative to the pristine surface. To attain an icephobic surface of the LLISS type, incorporation of hydrophobic nanoparticles, such as long aliphatic chain-anchored nanoparticles, into a coating matrix, incorporation of hydrophobic organic molecular segments into a sol-gel coating matrix, and development of a rough hydrophobic coating are the prevailed strategies. Of the two key structural characteristics, surface roughness has been considered to be more critical than hydrophobicity to implementing icephobicity. It has been observed that a superhydrophobic molecular segment layer covalently bound to a flat surface (Al) via silanization lacks icephobic durability. However, the complex topographical features of a LLISS increase ice nucleation sites and hence, promote ice adhesion compared to a smooth surface with similar surface composition in humid surrounding once ice is formed. On the other hand, to realize an icephobic surface of SLIPS type, a porous surface with roughness in micron or submicron level has to be impregnated by a lubricating liquid; for instance a hydrophilic porous substrate (cellulose) infused with aqueous solution of glycerine displays an anti-icing behavior. Nevertheless, hydrophobic oils are most often employed to construct icephobic SLIPS. The most inspired element of SLIPS is its liquid component at the lowest possible temperature because icing on liquid is slower than on a solid and also ice/liquid interface has much smaller adhesion strength. The key concept derived here is that the softness in terms of viscous trait at low temperatures, in particular the hydrophobic softness, is an essential element of icephobic coating. Both LLISS and SLIPS designs have yet to manifest feasibility towards pilot testing by far. This is partly because a practical aerospace icephobic coating must not only meet the regulations for aerospace paint such as Aircraft painting and finishing by FAA, it must also satisfy the requirement of easy maintenance and repair operation (MRO). There is obviously a technical gap between practical needs and these two cutting edge designs. For example, the SLIPS are easily to be polluted by dusts and also vulnerable to washing, a routine of MRO. Whereas for laying down a LLISS on the leading edges of aircraft, it has to satisfy with the requirements such as glossiness, adhesion to primer in a broad temperature range, electrostatic charge proof, etc. Besides, LLISS will encourage capillary condensation at high relative humidity percentages (RH %), leading to formation of a wide spread of ice nuclei once near freezing point. Practically, to realize an icephobic surface on the leading edges of wings and control surfaces (horizontal and vertical stabilizer) of aircraft, modifying the surface of an existing aerospace topcoat by a one-step approach is most cost effective and practically (MRO) viable.

There is therefore a need to find new materials for icephobic surfaces, especially thin icephobic coating (IpC) films being suitable to overly an aerospace hydrophobic PU topcoat.

### SUMMARY OF INVENTION

According a first aspect of the invention a segment copolymer is provided comprising rigid and soft segments wherein the soft segments are doped with a wax.

Advantageously, the segment copolymer can be used to make an icephobic coating with segregated soft hydrophobic microdomains spreading over the coating surface. Compared to LLISS or SLIPS concepts commonly used, the inventive concept explores a technically much more viable and simpler, but effective icephobic coating through designing a heterogeneous matrix comprising soft hydrophobic microdomains and rigid segments, where the concept of low-temperature softness and of the segregated softness at micron scale are the core of this invention. These two structural characteristics are essential to impede icing and deteriorate proliferation of crystal structure of ice. The IpC is then derived from a specially formulated liquid solution of the segment copolymer that includes paraffin wax dopant and a chemical curing agent. Such improvement, i.e. weakened ice adhesion, is related to the micron-scaled heterogeneity consisting of rigid segments and soft hydrophobic microdomains, which induces massively twisted ice phases in contact with the coating surface and leads to a drastic reduction in strong ice-biting sites on the coating surface. It is suitable to overly an aerospace hydrophobic PU topcoat.

According to one embodiment a segment copolymer is provided consisting of rigid and soft segments wherein the soft segments are doped with a wax.

According to another embodiment of the invention the rigid segments comprise polymer chains comprising monomer units selected from methacrylate, styrene, acrylonitrile butadiene styrene, 4-hydroxylbenzoic acid, vinyl chloride, or monomers made from bisphenol A (BPA) pre-monomers. These embodiments use specific monomers in the rigid segment. Rigid segments are essential, because otherwise any coating made from the polymer will give rise to a very soft coating surface that does not meet the requirement for dimensional stability and also undertakes a faster icing than counterpart with rigid segments. According to another embodiment the soft segments comprise a polymer chain comprising monomer units bearing a linear or branched side chain selected from C₁₀ (decyl) to C₁₈ (octadecyl) alkyl groups. These groups allow for an excellent capability to capture the wax to obtain a wax doped segment copolymer. In another embodiment the soft segment additionally comprises monomers with organic functional groups that can be crosslinked via a crosslinker. This ensures that an optimal structured coating can be obtained by curing with the crosslinker. In a further embodiment the functional groups are located on side chains close to the main polymer chain of the copolymer which helps to achieve an optimal sizing and spreading of segregated soft hydrophobic microdomains over the coating surface when the polymer is being used in a coating.

In yet another embodiment a model for a segmented polymer has been provided wherein the rigid segments substantially consist of polymer chains of methyl methacrylate (MMA) and the rigid segments surround the segregated soft segments which substantially consist of a copolymer of a lauryl methacrylate (LMA) monomer and an adduct monomer of glycidyl methacrylate (GMA) and 1-dodecylamine (DDA). The term “surround” in this regard means that the different monomers are not arbitrarily distributed over the polymer and that each soft segment of significant length is in between rigid segments of significant length. Therefore a segmented polymer is not just a polymer with one polymer block in the middle capped with other polymers at both ends. The tri-component segment copolymer of this embodiment has three structural characteristics: 1.) Formation of PMMA rigid segments and P(LMA—GMA⊥DDA) soft segments in each individual copolymer chains because MMA has a weak tendency to evenly copolymerized with either LMA or GMA⊥DDA; while the latter two monomers have very similar structures and hence strong tendency to form a segment with well mixing of the two; 2.) Both LMA and GMA⊥DDA monomers bear C-12 linear and saturated aliphatic side chains; and 3.) The presence of a pendant amine (—NH—) and a pendant hydroxyl (—OH) groups at each monomer unit of GMA⊥DDA near to the backbone. As such, each copolymer chain consists of randomly distributed PMMA and P(LMA—GMA⊥DDA) segments. The PMMA segments contribute physical rigidity to the matrix of IpC film made by solution casting. The aliphatic side chains of the P(LMA-GMA⊥DDA) segments fix the wax molecules added through chain entangling, driven by structural similarity, to constitute soft and hydrophobic microdomains. Formation of segregated microdomains rather than larger patches is because only a few P(LMA-GMA⊥DDA) segments (from the same or different polymer molecules) are spatially nearby due to the portioning role of PMMA segments. FIG. 1 shows the schematic approach of making the tricomponent polymer. Additionally, curing agent, for instance, isophorone diisocyanate (IPDI), introduced to the coating formulation of the polymer can crosslink the pendant hydroxyl and amine groups borne by the P(LMA-GMA⊥DDA) segments in individual domains. As a result, the final coating matrix consists of soft hydrophobic P(LMA-GMA⊥DDA)⊗IPDI microdomains and PMMA segments, which are interlocked as depicted in FIG. 2. The icephobic property of this IpC can be attributed to the discrepant physicochemical properties between PMMA segments and P(LMA-GMA⊥DDA)⊗IPDI microdomains. This discrepancy is extended through incorporation of a small amount of wax into the copolymer, because the wax molecules promote local aggregation of P(LMA-GMA⊥L DDA)) segments through their entangling with the aliphatic side chains; the individual aggregates formed are eventually fixed through IPDI, the curing agent, which crosslinks —OH and —NH— groups. In parallel with this, each P(LMA-GMA⊥DDA))⊗IPDI microdomain formed is surrounded by more PMMA segments. Such segregation of the P(LMAGMA⊥DDA))⊗IPDI microdomains imposes an interference with the propagating of icing nuclei to form an ice layer. This is because the homogeneous solidification must go through an initial nucleation stage, in which nuclei formed will increase when they are larger than the critical nucleus size determined by a particular temperature, which becomes smaller with the decrease in temperature. Hence, to prevent icing at a low temperature, supercooled water droplets formed on the microdomains due to chaotic water molecule assembly inside the droplets, to function as micro heat reservoirs. These supercooled water droplets confine the nucleation of ice along their boundary through supplying heat to overlying tiny ice nuclei and then to slow down their growth. Too small microdomains will have difficulty in sustaining supercooled water droplets to repress the growth of ice nuclei nearby because of a lack of adequate interfacial perturbing strength. In consequence, the growth of these ice nuclei will in turn promote icing in the supercooled water droplets. It is therefore advisable to have segment copolymer chain structure where long enough P(LMA-GMA⊥DDA) segments are formed through the assistance of the wax-doping, which will constitute the microdomains after coating and curing. These resulting microdomains should be able to retain supercooled water droplets overlying them in order to retard icing surrounding them with the decrease in temperature. This de-icing mechanism depends on the domain size as well as its softness, where mixing between the aliphatic side chains and wax is critical. It has been confirmed that placing a wax layer on the PU topcoat does not help de-icing.

The optimal mixing would extend chain flexibility of wax at a lowest possible temperature since dynamic chain motions are essential in keeping entropy of water molecules inside the droplet, namely an effect of chemical agitation. As far as the role of PMMA segments is concerned, they maintain dimensional stability of the coating through segregating the soft hydrophobic segments into microdomains by rigid segments. To confirm this point, a control coating made only of wax-doped P(LMA-GMA⊥DDA)⊗IPDI on the same PU substrate gives rise to a very soft coating surface that does not meet the requirement for dimensional stability and also undertakes a faster icing than its PMMA-containing counterpart. Its weaker de-icing capability can be caused by a lack of micro heterogeneity that is imperative to break down continuity of water phase because the bulk of water is affected by the discrepant soft and rigid polymer topographies, which could thereby facilitate impeding proliferation of the nucleation of ice. In addition, the microdomain size ensures adequate hydrophobic softness because the extent of chain entanglement is effectively confined with the decrease in size due to spatial proximity.

In one embodiment the tri-component polymer is a segment copolymer wherein the molar ratio of the monomer units MMA:LMA:(GMA/DDA) is about 10:1:4. Similar ranges may be an optimal size range for wax-doped P(LMAGMA⊥DDA⊗IPDI soft hydrophobic microdomains to fulfil the contrary needs for forming large enough hydrophobic soft domains in order to supply sufficient entropy to the overlying supercooled water droplets and also for maintaining rigid segments surrounding the soft domains. The fractions of the both types of segments in the copolymer and wax doping extent determine the attainment of an obvious icephobic performance over the coating, but may vary according to the monomers used in the copolymer.

In yet another embodiment wax additives are used in the doping of wax, such as a polyethylene, polypropylene or polyamide oligomers. The additives can enhance the stability of wax in the coatings made from the polymer against washing and scrubbing.

According to a second aspect of the invention there is provided a process for making a segment copolymer according to the first aspect of the invention comprising the following steps: (i) synthesizing a segmented copolymer by reacting the monomers of the soft segment and the rigid segment and (ii) adding wax to the segment copolymer. In one embodiment the wax is added during the synthesis of the polymer. This enhances the formation of improved segmentation between rigid and soft segments during the synthesis by supporting the formation of long enough soft segments, which will constitute the microdomains after coating and curing. In a further embodiment of the process the segment copolymer is made in a free-radical polymerisation and segmentation is achieved by a stronger self-polymerization of the monomers of the rigid segment compared with the copolymerization with the monomers of the soft segment. This further improves segmentation between rigid and soft segments of best suitable chain length.

According to a third aspect of the invention, there is also provided coating with hydrophobic microdomains surrounded by the rigid segments obtained by curing a coating solution comprising the segment copolymer according to the first aspect of the invention. Advantageously the coatings have an improved icephobic surface and can be used in various applications where surface icing is a problem. The coatings can be made according to a process for making such coating comprising the steps of (i) providing a coating solution of the segmented polymer of the first aspect of the invention and (ii) curing the coating solution. In one embodiment the introduced functional groups in the segmented polymer are used during curing of the coating by a crosslinker. This curing method supports a good segregation of the segregated soft hydrophobic microdomains surrounded by rigid areas. The coating is icephobic and provides advantages with regard to a delay of icing and weakened ice adhesion.

This process is another aspect of the invention as well as a coating solution comprising the segment copolymer of the first aspect of the invention in a solution together with a chemical curing agent. The coating solution can be used in a method for coating the surface of a metal, a thermosetting polymer substrate or a thermoplastic polymer substrate.

### Definitions

The following words and terms used herein shall have the meaning indicated:

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations or any two or more of said steps or features.

As used herein, the term “wax” refers to organic compounds that characteristically comprise long alkyl chains. They may also include various functional groups such as fatty acids, primary and secondary long chain alcohols, unsaturated bonds, aromatics, amides, ketones, and aldehydes. They may be for instance selected from linear alkanes, the branched alkanes, aromatic or naphthenic substituted alkanes, or glycerides. According to this disclosure synthetic waxes may be particularly mentioned which comprise long-chain hydrocarbons (alkanes or paraffins) that lack functional groups.

As used herein, the term “paraffin wax” refers to a soft solid derivable from petroleum, coal or oil shale, that consists of a mixture of hydrocarbon molecules containing between twenty and forty carbon atoms.

As used herein, the term “rigid segment” may refer to a rigid polymer chain that cannot move around more easily based on the monomer it is made from, while the term “soft segment” refers to polymer chain that move well, in particular at temperatures below the normal freezing point. The term “rigid segment” may refer to a polymer chain of a polymer with a higher glass transition temperature (T_{G}) based it monomers while the term “soft segment” refers to a polymer chain of a polymer with a lower glass transition temperature (T_{G}) based its monomers.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Unless specified otherwise, the terms “comprising” and “comprise”, and grammatical variants thereof, are intended to represent “open” or “inclusive” language such that they include recited elements but also permit inclusion of additional, not recited elements. The terms “comprising” and “comprise” always include their meaning “consisting of” and “consist of” without being limited thereto.

The word “substantially” does not exclude “completely” e.g. a composition which is “substantially not leaking” may be completely tight without any leakage. Where necessary, the word “substantially” may be omitted from the definition of the invention.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Non-limiting embodiments of the invention will be further described in greater detail by reference to specific examples, which should not be construed as in any way limiting the scope of the invention.

According a first aspect of the invention a segment copolymer is provided comprising rigid and soft segments wherein the soft segments are doped with a wax.

The soft and rigid segments of the copolymer can be achieved by choosing the respective monomers to make the polymer. The rigid segments of the polymer comprise polymer chains from monomers that can be polymerized into polymers with high glass transition temperature. Examples include monomers of homopolymers that can have a glass transition temperature (T_{g}) of more than 70° C., preferably between about 70° C. and 200° C., most preferably between about 80° C. and 140° C. Typical monomers that can be mentioned include methacrylate, styrene, acrylonitrile, phenyl methacrylate, pentachlorophenyl acrylate, or monomers from derivative of styrene, such as p-chlorostyrene. The rigid segments may surround the soft segments.

In an embodiment, the copolymer may have a chain length of from about 1200 to about 3500 repeating units.

As the polymer chain of the rigid segment poly(methacrylate) (PPMA) can be particularly mentioned. It can be synthesized from methyl methacrylate (MMA) monomers.

The soft segments of the polymer comprise polymer chains from monomers that can be polymerized into polymers with a lower glass transition temperature than the rigid segments polymer chains. Monomers that can be particularly mentioned include monomer units bearing long aliphatic side chains. These side chains can be branched or linear and can be for instance selected from a side chain selected from linear or branched C₁₀ (decyl) to C₁₈ (octadecyl) alkyl groups which are optionally fastened to the main polymer chain by —NH—, —CO—, —C(O)—O—, —C(O)—NH— or —O— groups. Possible substituents of the long-chain alkyl groups that can be mentioned include organic halides such as perchloro or perfluoro chains. All monomers that are substituted with linear or branched C₁₀ (decyl) to C₁₈ (octadecyl) alkyl groups of the type described above can be used. As monomers of the soft segment there can be particularly mentioned methacrylate or methacrylate derivatives that are substituted with the long aliphatic side chains, such as for instance lauryl methacrylate (LMA) and adduct products of glycidyl methacrylate (GMA). Adducts of glycidyl methacrylates with respective C₁₀ to C₁₈ alkyl amines have been provided as functional monomers according to this invention.

In an embodiment, the copolymer may have a chain length of from about 1200 to about 3500 repeating units, or about 1200 to about 3450, about 1200 to about 3400, about 1200 to about 3350, about 1200 to about 3300, about 1200 to about 3250, about 1200 to about 3200, about 1200 to about 3150, about 1200 to about 3100, about 1200 to about 3050, about 1200 to about 3000, about 1200 to about 2950, about 1200 to about 2900, about 1200 to about 2850, about 1200 to about 2800, about 1200 to about 2750, about 1200 to about 2700, about 1200 to about 2650, about 1200 to about 2600, about 1200 to about 2550, about 1200 to about 2500, about 1200 to about 2450, about 1200 to about 2400, about 1200 to about 2350, about 1200 to about 2300, about 1200 to about 2250, about 1200 to about 2200, about 1200 to about 2150, about 1200 to about 2100, about 1200 to about 2050, about 1200 to about 2000, about 1200 to about 1950, about 1200 to about 1900, about 1200 to about 1850, about 1200 to about 1800, about 1200 to about 1750, about 1200 to about 1700, about 1200 to about 1650, about 1200 to about 1600, about 1200 to about 1550, about 1200 to about 1500, about 1200 to about 1450, about 1200 to about 1400, about 1200 to about 1350, about 1200 to about 1300, about 1200 to about 1250, about 1250 to about 3450, about 1300 to about 3450, about 1350 to about 3450, about 1400 to about 3450, about 1450 to about 3450, about 1500 to about 3450, about 1550 to about 3450, about 1600 to about 3450, about 1650 to about 3450, about 1700 to about 3450, about 1750 to about 3450, about 1800 to about 3450, about 1850 to about 3450, about 1900 to about 3450, about 1950 to about 3450, about 2000 to about 3450, about 2050 to about 3450, about 2100 to about 3450, about 2150 to about 3450, about 2200 to about 3450, about 2250 to about 3450, about 2300 to about 3450, about 2350 to about 3450, about 2400 to about 3450, about 2450 to about 3450, about 2500 to about 3450, about 2550 to about 3450, about 2600 to about 3450, about 2650 to about 3450, about 2700 to about 3450, about 2750 to about 3450, about 2800 to about 3450, about 2850 to about 3450, about 2900 to about 3450, about 2950 to about 3450, about 3000 to about 3450, about 3050 to about 3450, about 3100 to about 3450, about 3150 to about 3450, about 3200 to about 3450, about 3250 to about 3450, about 3300 to about 3450, about 3350 to about 3450, about 3400 to about 3450, or about 1200, about 1250, about 1300, about 1350, about 1400, about 1450, about 1500, about 1550, about 1600, about 1650, about 1700, about 1750, about 1800, about 1850, about 1900, about 1950, about 2000, about 2050, about 2100, about 2150, about 2200, about 2250, about 2300, about 2350, about 2400, about 2450, about 2500, about 2550, about 2600, about 2650, about 2700, about 2750, about 2800, about 2850, about 2900, about 2950, about 3000, about 3050, about 3100, about 3150, about 3200, about 3250, about 3300, about 3350, about 3400, about 3450 repeating units, or any value or range therein.

According to an embodiment the polymer chain of the soft segment additionally comprises monomers with organic functional groups that can be crosslinked. These functional groups may be crosslinked in commonly known click or condensation chemical reactions. A crosslinker may be used to crosslink the functional groups. An aliphatic or aromatic diisocyanate may be particularly mentioned such as e.g. the aliphatic isocyanates hexamethylene diisocyanate or isophorone diisocyanate (IPDI). In one embodiment the functional groups are located on the side chains close to the main chain of the polymer backbone. Preferably they can be introduced with the aliphatic side chain of one per soft monomer unit. They can be for instance be introduced by using a monomer which is an adduct of glycidyl methacrylate with an aliphatic organic amine, such as an C₁₀-C₁₈ alkyl amine. An adduct of 1-dodecylamine and glycidyl methacrylate can be particularly mentioned (GMA L DDA). The functional groups can be chosen according to the crosslinking reaction type chosen for curing the segmented polymer to form a coating. —NH—, —OH, —SH, —NH₂, —N₃, C₃ to C₇ alkynyl, or COOH groups can be particularly mentioned. —NH— and —OH groups may be preferred.

The average weight ratio of rigid segment to soft segment may be varied broadly. It may be between about 1 and 0.1, preferably about 0.75 to 0.33.

The molar ratio of the rigid and soft segments could be even wider then described above, if another polymer synthesis approach is used (e.g. a step copolymerisation).

According to one embodiment the segment copolymer is provided wherein the monomers of the segment copolymer comprise methyl methacrylate (MMA), lauryl methacrylate (LMA) and an adduct monomer of glycidyl methacrylate (GMA) and 1-dodecylamine (DDA). The monomers can be used in various ratios, but the following molar ratios may be preferred:

LMA: (GMA/DDA) is 1:1 to 1:10; 1:2 to 1:6 or 1:3 to 1:5, particularly about 1:4

PMMA: (LMA and (GMA/DDA) is 5:1 to 1:2; 4:1 to 1:1 or 3:1 to 1.5:1, particularly about 2:1.

A molar ratio of about 10:1:4 of PMMA:LMA:(GMA/DDA) or a mass ratio of about 10:2.5:13 can be mentioned.

The mass ratio between polymer parts of the rigid segment to the soft hydrophobic domains may be chosen between 1:1.2 to 1:3 or 1:1.3 to 1:2, particularly about 1:1.55.

The soft segments are doped with a wax. This means that a certain amount of wax is added during the synthesis of the segment polymer from its monomers or thereafter. The wax molecules show a high affinity to the long alkyl chains in the soft segment (doping) and are physically bonding with the soft segment monomers. The physical bonding is based of entangling of the hydrophobic chains in both the wax and polymer side chains. Preferably the wax is added during the synthesis to support the formation of longer polymer chains of the soft segment. The wax may be selected from linear alkanes, branched alkanes, aromatic or naphthenic substituted alkanes, or glycerides. The wax may be a paraffin wax. A wax that has an average linear chain length containing 25 carbons may be particularly mention, such as e.g. C₂₅H₅₂. However other linear alkanes, branched alkanes, aromatic or naphthenic substituted alkanes with similar molecular weights, or glycerides with melting points comparable with the paraffin wax would be possible alternatives.

Small amounts of wax may be used during doping to achieve the desired coating material capabilities. The overall amount of wax used for the doping may be chosen in the range between 4 to 20 mg per g of the copolymer. Amounts of 1 mg to 100 mg may however be also possible depending on the polymer backbone structure of the two segments. Small amounts of 3 to 10 mg may be preferred. Other contents that can be mentioned include 2, 4, 5, 7, 9, 15, 25, 66, 75 or 90 mg wax per g of copolymer.

Preferably the weight ratio of wax to the monomers of the soft segment is 0.1 to 10 wt %, most preferably 0.8 to 3.2 wt %. Other weight ratios that can be mentioned include 0.3, 0.5, 1.0, 2.0, 2.5, 3.0, or 3.8 wt %. It can also be a molar ratio of wax to the monomers of the soft segment of 0.1 to 6 mol %, most preferably 0.6 to 2.5 mol %.

The wax doped segment polymer can be kept in solution with the wax for later use in coating applications without isolation. Preferably is kept in the reaction solvent of its synthesis, preferably as homogenous solution. The doped polymer may be used directly from the reaction solution of its synthesis. Preferably the reaction and storage solvent for the segment copolymer may be selected from inert organic solvent such as toluene, ethyl acetate, acetophenone, or xylenes to obtain a homogenous copolymer solution.

The doping with the wax can be improved by adding wax additives. Such optional wax additives may be selected from polyethylene, polypropylene, perfluoroacrylate, silicone or polyamide oligomers.

Polyethylene oligomers may be preferred. These oligomers preferably have a number average molecular weight (Mₙ) of 500 to 9,000, preferably 1,000 to 3,000, more particular 1,500 to 2,000. A Mₙ of 1700 a.u. for polyethylene wax additives can be particularly mentioned. The weight ratio of wax additive, such as e.g. polyethylene oligomer, to the wax is about 25 to 55%, it can however be varied between 10 to 60% or chosen in a narrower range of 30 to 40%.

According to a second aspect of the invention a process for making the segment copolymer of first aspect of the invention is provided comprising the following steps: (i) synthesizing a segmented copolymer by reacting the monomers of the soft segment and the rigid segment and (ii) adding wax to the segment copolymer.

In step (i) of the process the monomers are reacted to form the segmented copolymer. Depending on the monomers used, a known polymerization reaction can be chosen. A free radical polymerization can be particularly mentioned, but other polymerization synthesis approaches are also suitable to make the segment copolymer. Methacrylate monomers can be polymerized in such free radical polymerization. Reacting the soft segment monomers and rigid segment polymers in one reaction may be preferred. This reaction type may be especially used when the monomers of the two segments by itself or supported by other means (e.g. adding the wax during reaction) show a tendency to preferably polymerize with its kind which means that longer chains of rigid segment are combined with longer chains of the soft segment. In one embodiment segmentation is for instance achieved by a stronger self-polymerization of the monomers of the rigid segment compared with the copolymerization with the monomers of the soft segment. In another embodiment more than one monomer type is used in the segments and those monomers have very strong mutual copolymerization propensity, e.g. the two monomers of the soft segment.

The monomers used in step (i) can be those described above with regard to the monomer of the segment copolymer. According to one embodiment at least one type of monomers of the soft segment comprises branched or linear aliphatic side chains of C₁₀ to C₁₈.

Other reaction types available for the synthesis include step copolymerization of the segments of the copolymer. In this case the copolymer builds up the molecular weight of polymer by stepwise function. Different functionalities are known from polymer handbooks for this reaction type. The copolymer then can also be a polyester, polyamide, polyurethane, etc. The synthesis approach for the copolymer is not critical, if the segmentation is achieved. An important factor is the wax doping which is available to various segmented polymer types.

The reaction in step (i) preferably takes place in an inert organic solvent at elevated temperatures and optionally under inert gas atmosphere (e.g. argon). Temperatures of between about 40° C. and 200° C., more preferably between about 60° C. and 120° C. and most preferably between about 65° C. and 100° C. can be mentioned. The reaction time may be about 10 to 36 hours and preferably about 18 to 30 hours, but is not a critical feature. The organic solvent is preferably selected from toluene, ethyl acetate, acetophenone, or xylenes. These solvents are particularly mentioned for a free radical polymerization.

Initiators may support the polymerization in step (i). In case of a free radical polymerization the initiators may be selected from known initiators based on photolysis (such as azobisisobutyronitrile) or thermal decomposition. The initiator may be used in typical amounts such as for instance about 0.1 to 10 mol % with respect to total monomers, preferably about 0.5 to 2 mol %.

The process wherein in step (i) the monomers comprise methyl methacrylate (MMA), lauryl methacrylate (LMA) and an adduct monomer of glycidylmethacrylate (GMA) and 1-dodecylamine (DDA) is another embodiment. The monomers can then be used in the amounts as described under the first aspect of the invention.

In one embodiment two monomers are used for making the soft segment. They can be of an identical core monomer type (e.g. methacrylates). The second functionalized component monomer can be made by reaction of a functional group of the monomer with another molecule that carries a corresponding functional group. For instance a glycidyl group can be reacted with an amine at elevated temperatures, such as 35 to 80° C. The amine may comprise the long aliphatic side chains as mentioned above as a preferable structural element of the soft segment of the copolymer.

The making of the polymer includes the addition of wax in step (ii). The wax can be added during the synthesis of the polymer or after the synthesis of the polymer. It must however be added before further curing the final segment copolymer to form a coating. The wax is then captured in the hydrophobic microdomains of the coating. The wax may be added during the synthesis of the copolymer. In this regard step (ii) is integrated in step (i). The wax may for instance be added during the free radical polymerization together with the monomers in the inert organic solvent. The wax may support the segmentation during the synthesis of the polymer. This may be achieved by promoting the formation of segment copolymer chain structure because of the preferential association between the long aliphatic side chains and wax molecules.

A wax additive may be added together with the wax in step (ii) or the integrated step (i)/(ii). The wax additive can be of a type and usage amount as described above for the first aspect of the invention. It is preferably added together with the wax during synthesis of the polymer.

According to a third aspect of the invention, there is also provided a coating with hydrophobic microdomains surrounded by the rigid segments obtained by curing a coating solution comprising the segment copolymer according to the first aspect of the invention. The coating shows icephobic behaviour due to wax causing aggregation of the spatially nearby soft hydrophobic segments while the coating matrix is formed via drying. The subsequent curing of these soft aggregates by a diisocyanate reagent results in formation of soft hydrophobic microdomains surrounded by the rigid segments of the copolymer. The resultant heterogeneous matrix, i.e. the segregated soft hydrophobic domains in micron scale, contributes to a reduction of water contact angle hysteresis (WCAH) due to the increase in hydrophobic softness, a delay to the formation of ice, and a reduction in the adhesion strength of ice to it. The general structural characteristics are essential to impede icing and deteriorate proliferation of crystal structure of ice

The coating can be made from the segment copolymer alone or a mixture of the segment copolymer with other polymers. Preferably the coating is made from a coating solution with solid content of about 5 to 70%, preferably 10 to 25% in mass. A solid content of 17% in mass may be particularly mentioned. Depending of the area of application the coating may comprise typical additives and fillers as they are known from the prior art. The thickness of the coating layer may be widely varied. It may be about 10 to 100 μm, preferably about 50 to 75 μm. A coating thickness of about 60 μm may be particularly mentioned.

The process for making the coating is another aspect of the invention. The process comprises the steps of (a) providing a coating solution of the segmented copolymer according to the first aspect and (b) curing the coating solution. The curing may be done by known polymerization techniques known from the prior art which includes click or condensation types of chemical reactions. Preferably the organic functional groups that have been introduced in the segment copolymer as described above can be crosslinked in step (b).

The reaction in step (b) preferably takes place in an inert organic solvent at elevated temperatures. Temperatures of between about 40° C. and 200° C., more preferably between about 60° C. and 120° C. and most preferably between about 65° C. and 100° C. can be mentioned. The reaction time in this curing and drying step may be about 10 to 36 hours and preferably about 18 to 24 hours, but is not a critical feature. The organic solvent is preferably selected from toluene, ethyl acetate, acetophenone, or xylenes. These solvents are particularly mentioned for a free radical polymerization. According to one embodiment the polymer solution form the synthesis of the segment copolymer is used directly without purification after adding a curing agent. The solution can be casted on the desired surface. The curing agent to be added depends on the curing type. In case that —OH and —NH— groups have been introduced into the segment copolymer the curing agent can be for instance selected from aliphatic or aromatic diisocyanates as described above. The curing agent may then be added at a content of about 0.2 to 0.6 —OH equ., preferably about 0.3 to 0.5 —OH equ. with regard to the polymer. The diisocyanate curing can be supported by catalysts, such as tin compounds. Dibutyltindilaurate may be particularly mentioned. The catalysts can be used in common amounts preferably about 0.1 to 1 mol %, more preferably 0.4 tool % with regard to the curing agent.

The coating solution comprising the segment copolymer of the first aspect of the invention in a solution together with a chemical curing agent is another part of the invention. Preferably the coating is made from a coating solution with solid content of about 5 to 70%, preferably 10 to 25% in mass. A solid content of 17% in mass may be particularly mentioned. Depending of the area of application the coating solution may comprise typical additives and fillers as they are known from the prior art for this field. 1 g coating solution may be used to coat an area of 3.5×3.5 cm² to obtain a thin polymer film of about 10 to 100 μm thickness after curing.

The coating solution can be used in a method for coating the surface of a metal, a thermosetting polymer substrate or a thermoplastic polymer substrate. The method comprises the step of applying, e.g. by simple casting, the coating solution to the surface and curing.

### EXAMPLES

The segment copolymer and the icephobic coatings are characterized in the following examples which in no way limit the invention to the scope of the examples.

The examples show that a polymer coating film has been found whose matrix consists of segregated soft domains doped by wax that supports icephobic performance. Spreading of segregated soft hydrophobic microdomains is shown to be a simple alternative to SLIPS for the design for icephobic coatings. They further show that such design was realized through the synthesis of a copolymer comprising rigid and soft (hydrophobic) segments, which upon coating and chemical crosslinking gives rise to the above matrix characteristics.

The resultant IpC surface shows a significantly stronger icephobic property than the unmodified PU coating (blank) according to the measurement of icing extent with cooling and the ice—coating adhesion strength and toughness as demonstrated below. A commercial icephobic coating (NuSil R-2180 by NuSil Technology) on PU, chosen as a control, also shows apparently weaker icephobic property than the modified PU.

### Example A

Synthesis of P(MMA-LMA-GMA⊥DDA) Segment Copolymer

Step 1. Synthesis of GMA⊥DDA Adduct:

DDA (8.15 g, 43.98 mmol) is added to a one-neck round bottom flask equipped with a magnetic stirrer and then sealed with a rubber septum. The solid is heated to 45° C. in an oil bath for about 20 min to form a clear liquid. GMA (6 mL, 43.98 mmol) is then introduced using a syringe and the mixture is stirred at 45° C. for 8 h to complete the synthesis of the adduct monomer, GMA⊥DDA.

Step 2. Synthesis of Segment Copolymer by Free-Radical Copolymerization

For a typical synthesis, GMA⊥DDA (2.04 g, 6.24 mmol), MMA (1.56 g, 15.60 mmol), LMA (0.40 g, 1.56 mmol), paraffin wax (with mp.=56-58° C., or an average formula of C₂₅H₅₂) in the range from 0 to 155.9 mg, AIBN (1 mol % with respect to total monomers) and toluene (20 g) are added to a one-neck round bottom flask equipped with a magnetic stirrer and then sealed with a rubber septum. The mixture is purged with argon for 20 minutes, and then heated in an oil-bath at 70° C. to initiate the free radical polymerization. The reaction is carried out for 24 h and the resulting coating solution, with a solid content of 17% in mass, is used without further purification.

### Example B

Preparation of a PU Topcoat on an Aluminium Plate

An Aluminum (Al) plate (7075-T6, 3.5×3.5/cm²) is cleaned through ultrasonication in ethanol for 5 min and then etched with aluminum brightener (Actane E-10, Meltex), at 70° C. for 1 minute to remove the oxide layer. Primer (Urethane compatible high solids primer, 7755A, PPG) and primer activator (7755BE, PPG) is mixed in a glass vial (1/1 v/v), agitated at 500 rpm for 0.5 hr before use. The mixture is then applied onto the cleaned Al plate using a paintbrush, and the coated substrate is dried under ambient condition for 1 day. PU topcoat (8000B, PPG), activator and thinner (2/1/1 by vol.) are mixed thoroughly and applied evenly onto the primer layer immediately using a plastic dropper. This is left to dry and cure at room temperature for 24 hrs before using an oven to further cure at 60° C. for another 24 hrs to assure achieving a thermodynamically stable surface.

### Example C

Laying Down an Icephobic Coating Film on the PU Topcoat

The polymer coating solution (1 g), obtained from procedure A (step 2), is weighed in a dried 1.5-mL GC vial, following by addition of isophorone diisocyanate (IPDI, 0.4 —OH equiv. with respect to polymer) and dibutyltindilaurate (0.5 mol % with respect to IPDI) using micro-pipette. After mechanical agitation for 30 s, the mixture is immediately applied evenly onto the PU topcoat on an Al plate, subsequently the coating is subjected to curing at 80° C. for 20 hrs to complete the development of an IpC film. Typical coating recipes are listed in Table 1.

To mechanically enhance the soft hydrophobic domain, a selected oligomer of polyethylene (Mₙ=1700 a.u.) was introduced together with wax to dope the soft hydrophobic domain as shown in Table 1 in some cases. This enhancement showed a strengthening effect on the icephobic performance while the coating is subjected to the washing and scrubbing test.

The matrices of the IpC films were analyzed by the differential scanning calorimeter (DSC, TA Instruments DSC Q100) by loading 2-3 mg sample for each scan. A cyclic scanning profile, 25 to 120° C. at 5° C./min, 120 to −20° C. at 5° C./min and −20 to 120° C. at 5° C./min, was set to standardize the thermal history for each sample. The data obtained from the second heating cycle was collated. Results are shown in FIG. 3.

[Table 1] shows the recipe for the preparation of selected hydrophobic coating solutions (^{a} mass based on per 2 g of total monomers charged; ^{b} Adduct monomer based on glycidyl methacrylate and 1-dodecylamine; Sample with highest wax loading (10 mol %) for DSC analysis; ^{d} GMA⊥DDA/LMA/MMA=4/1/10 (mol/mol)=13/2.5/10 (mass/mass)).

TABLE 1

| | | Wax/ | PE/ | | |
|---|---|---|---|---|---|
| | GMA⊥DDA^{b}/ | (GMA⊥DDA + | (GMA⊥DDA + | | |
| | LMA/MMA | LMA) | LMA) | Wax^{a} | PE^{a} |
| Sample | (mol/mol) | (mass %) | (mass %) | (mg) | (mg) |
| C1 | 0/0/1 | | | | |
| C2 | 0/1/10 | | | | |
| S1 | 4/1/10^{d} | | | | |
| S1B^{c} | 4/1/10 | 12.78 | — | 155.9 | — |
| S2 | 4/1/10 | 3.20 | — | 39.0 | — |
| S3 | 4/1/10 | 0.80 | — | 9.7 | — |
| S4 | 4/1/10 | — | 1.70 | — | 20.7 |
| S5 | 4/1/10 | 3.20 | 1.70 | 39.0 | 20.7 |
| S6 | 4/1/10 | 3.20 | 0.85 | 39.0 | 10.4 |
| S7 | 4/1/10 | 3.20 | — | 39.0 | — |

### Example D

Characterizations of Surface Structures and Properties

To perform surface analysis by atomic force microscopy (AFM, Bruker Dimension ICON) samples were made directly casted, dried and cured on a microscope glass slide to prevent any chemical or physical interference arisen from the interface with PU. The analysis used the tapping mode scanning frequency of 0.6-1.0 Hz, 2-D depth profile and phase image acquired from build-in software (NanoScope Analysis 1.40). Results are shown in FIG. 4.

The morphology variations from the pristine PU topcoat to those on the selected IpC were carried out on a Field Emission Scanning Electron Microscope (FE-SEM, JOEL JSM-6700). Results are shown in FIGS. 5 to 6. The surface icephobicity arises from a special type of heterogeneity consisting of soft hydrophobic microdomains and rigid PMMA segments. These soft hydrophobic domains contain the dissolved wax as well as a sparse distribution of wax crystallites in the case the dose of wax reaches 0.8% in mass based on wax/soft segment (S3 in Table 1 and FIG. 5). Both rigid PMMA segments and soft hydrophobic microdomains function collectively to provide icephobic performance through holding supercooled water at temperature down to −15° C. Macroscopically, obvious delay of icing and reduction of the ice adhesion to the IpC are observed.

The segment copolymer comprises rigid PMMA segments and soft hydrophobic P(LMA-GMA⊥DDA) segments in individual polymer chains. When this copolymer is synthesized through free radical copolymerization of the three monomers, MMA, LMA, and GMA⊥DDA, a given amount of paraffin wax must be present since the blending of wax molecules with LMA and GMA⊥DDA promotes formation of segment copolymer chain structure because of the preferential association between the long aliphatic side chains and wax molecules with the exception of the weak tendency of MMA to form alternating copolymer with either LMA or GMA⊥DDA. After the copolymer solution is obtained, a diisocyanate curing agent (or crosslinker), IPDI, and a curing catalyst are introduced into the solution, which is then immediately cast on the PU substrate. After dying and curing at 80° C. for 20 hrs, a heterogeneous coating matrix comprising soft hydrophobic microdomains and rigid PMMA segments as shown in FIG. 6.

The apparent water contact angles (CA) on different surfaces were measured by the sessile drop method under ambient atmosphere using a contact angle goniometer (Ramé-Hart, Model 100-00). Deionized water droplets (5 μL) were dropped onto the sample surface using a built-in dispenser, and the average value of five measurements made on different locations was recorded. Furthermore, the contact angle hysteresis range was determined through measurement of the advancing and receding angles (OA and OR) as normally defined.

[Table 2] shows the results of the characterization of the roughness and hydrophobicity of the samples.

TABLE 2

| | Equivalent | | | | |
|---|---|---|---|---|---|
| | RMS | | | Receding | CA |
| | roughness | Water contact | Advancing | CA | Hysteresis |
| Sample | (nm) | angles (CA) | CA (θ_{A}) | (θ_{R}) | (θ_{A} − θ_{R}) |
| PU | 15.6 | 80.6 ± 0.4 | 82.1 | 54.2 | 27.9 |
| S1 | 1.77 | 84.6 ± 0.9 | 89.2 | 41.3 | 47.9 |
| S2 | 6.96 | 109.7 ± 0.4 | 114.7 | 106.3 | 8.4 |
| S3 | 2.57 | 108.9 ± 0.4 | 114.6 | 103.5 | 11.1 |
| S4 | 23.3 | 83.2 ± 1.1 | 88.1 | 43.9 | 44.2 |
| S5 | 10.5 | 108.6 ± 0.6 | 112.2 | 100.3 | 11.9 |
| S6 | 14.5 | 109.5 ± 0.6 | 114.4 | 102.2 | 12.2 |

### Example E

Determination of the Delay of Heterogeneous Ice Nucleation

The coating samples are placed horizontally on a Peltier cold plate (TeCa, AHP-1200CP) at ambient conditions (22° C. and RH %=70), as shown in FIG. 7. The plate is therefore gradually cooled down to −10° C. within about 15 min. The condensation of humid air and the subsequent freezing process of the water droplets was recorded and monitored by using a video camera (Canon IXUS 1000 HS) or a digital USB microscope (ViTiny UM12 USA).

The IpC is developed by a simple protocol including formulating the coating solution and thermal curing after drying a liquid layer of the coating solution on the PU substrate. The finally achieved icephobic coating (IpC) is 60±2 μm thick and transparent so that it retains the color of the PU topcoat underneath. The resulting IpC surface significantly reduces water contact angle hysteresis (WCAH) from 28 degree of the pristine PU topcoat to as low as 8 to 9 degree. In parallel, water droplets on the best IpC show a completion of freezing within up to 15 min from −7.1 to −10.8° C. in contrast to the PU substrate (the PPG aerospace hydrophobic topcoat) that shows the duration of 5 min from −6.3 to −8.8° C. The results are shown in FIG. 8.

### Example F

Sample Washing and Scrubbing Test

Although there is no direct ASTM method for testing the durability of an icephobic coating against washing and scrubbing thus far, we devised a test protocol, adapted from ASTM D4828-94 that provides a standard test method for practical washability of organic coatings. The sample plate (reference PU, Sample S2 and S6, 3.5×3.5 cm in Table 1) was mounted onto the middle of rotating platen of Buehler MetaServ® 2000 Grinder Polished Unit, using double-sided adhesive tape. Heavy duty Scoth-Brite® scrub sponge (10×7.5 3.5 cm, 3M Singapore Pte Ltd) was placed on top of the testing sample. A uniform compressive force of 2.4 N was imposed on the sponge by a pair of pellet dies, which result in an approximately constant normal stress of 320 Pa during the washing process. Tap water was supplied to moisten the sponge during the course of washing scrubbing test. The rotating platen was set at 40 rpm, while the sample was scrubbed against the wet sponge for 3 min, to simulate an effective washing motion of 120 strokes.

### Example G

Determination of the Shear-Stress/Interfacial Motion Curve

The critical shear stress between ice and coating surface is determined by using a setup as shown in FIG. 9. In details, 250 ml of deionized water is placed in a specific metal container, and the sample is then immersed in the container in a proper position to let water cover the major part of the coating. The container is then subjected to freezing in a freezer for up to 24 h. The metal container is mounted onto a Universal testing machine, with dry ice placed around the metal container to prevent the ice inside from melting. The Universal testing machine (Instron 5569 Table Universal testing machine) is then started to slowly pull the sample out of the ice, at a rate of 5 mm/min. Throughout the process the Bluehill software of the machine is used to record the shear stress incurred with time. The graph of shear stress against pull distance is then plotted, and the maximum shear stress is the critical shear stress indicating the adhesion strength of ice to the surface in question.

The IpC exhibits an apparent reduction in adhesion to ice conducted in the cold soak of dry ice (−78.5° C.) relative to the pristine PU substrate. The adhesion of ice to the testing sample is recorded by the rupture stress and, more importantly, the energy required for detaching ice from the coating. This is similar to the toughness for a sample under tension till its breaking point and is described by the area under the stress distance curve, which reflects the occurrence of tougher icing points on a coating surface to reject the shift of the ice-coating interface (FIG. 10). Compared with the pristine PU coating, the best IpC shows a rupture stress of 40 MPa and almost nil toughness at the ice-coating interface whereas the PU shows a rupture stress of 60 MPa and at least 6 times greater toughness than the above IpC. The IpC demonstrates a drastic reduction in strong ice-biting sites on the coating surface with the exception of a reduction in the rupture stress by about 30%. Such improvement, i.e. weakened ice adhesion, is related to the micron-scaled heterogeneity consisting of rigid segments and soft hydrophobic microdomains, which induces massively twisted ice phases in contact with the coating surface. As underscored above, fundamentally, the icephobic property of this IpC can be attributed to the discrepant physicochemical properties between PMMA segments and P(LMA-GMA⊥DDA)⊗IPDI microdomains. This discrepancy is extended through incorporation of a small amount of wax into the copolymer because the wax molecules promote local aggregation of P(LMA-GMA⊥DDA) segments through their entangling with the aliphatic side chains; the individual aggregates formed are eventually fixed through IPDI, the curing agent, to crosslink —OH and —NH— groups. In parallel with this, each P(LMA-GMA⊥DDA)⊗IPDI microdomain formed is surrounded by more PMMA segments. Such segregation of the P(LMA-GMA⊥DDA)⊗IPDI microdomains imposes an interference with the propagating of icing nuclei to form an ice layer. This is because the homogeneous solidification due to removal of fusion heat must go through an initial nucleation stage, in which nuclei formed will increase when they are larger than the critical nucleus size determined by a particular temperature, which becomes smaller with the decrease in temperature. Hence, to prevent icing at a low temperature, supercooled water droplets formed on the microdomains, to function as micro heat reservoirs, must be capable to confine the nucleation of ice along their boundary through supplying heat to tiny ice nuclei and then to slow down their growth. Too small microdomains will have difficulty in sustaining supercooled water droplets to repress the growth of ice nuclei nearby because of a lack of adequate interfacial perturbing strength. In consequence, the growth of these ice nuclei will in turn promote icing in the supercooled water droplets. It is therefore imperative to have segment copolymer chain structure where long enough P(LMA-GMA⊥DDA) segments are formed through the assistance of the wax-doping, which will constitute the microdomains after coating and curing. These resulting microdomains should be able to retain supercooled water droplets overlying them in order to retard icing surrounding them with the decrease in temperature. This de-icing mechanism depends on the domain size as well as its softness, where mixing between the aliphatic side chains and wax is critical. It has been confirmed that placing a wax layer on the PU topcoat does not help deicing. The optimal mixing would extend chain flexibility of wax at a lowest possible temperature since dynamic chain motions are essential in keeping entropy of water molecules inside the droplet, namely an effect of chemical agitation. As far as the role of PMMA segments is concerned, they maintain dimensional stability of the coating through segregating the soft hydrophobic segments into microdomains by rigid segments. To confirm this point, a control coating made only of wax-doped P(LMA-GMA⊥DDA)⊗IPDI on the same PU substrate gives rise to a very soft coating surface that does not meet the requirement for dimensional stability and also undertakes a faster icing than its PMMA-containing counterpart. Its weaker de-icing capability can be caused by a lack of micro heterogeneity that is imperative to break down continuity of water phase because the bulk of water is affected by the discrepant soft and rigid polymer topographies, which could thereby facilitate impeding proliferation of the nucleation of ice. In addition, the microdomain size ensures adequate hydrophobic softness because the extent of chain entanglement is effectively confined with the decrease in size.

### DESCRIPTION OF DRAWINGS

The accompanying drawings illustrate a disclosed embodiment or reaction scheme and serve to explain the principles of the disclosed embodiments. It is to be understood, however, that the drawings are designed for purposes of illustration of examples only, and not as a limitation of the invention.

FIG. 1 shows a scheme for the synthesis of adduct monomer, followed by solution polymerization with MMA and LMA to form comb like copolymer.

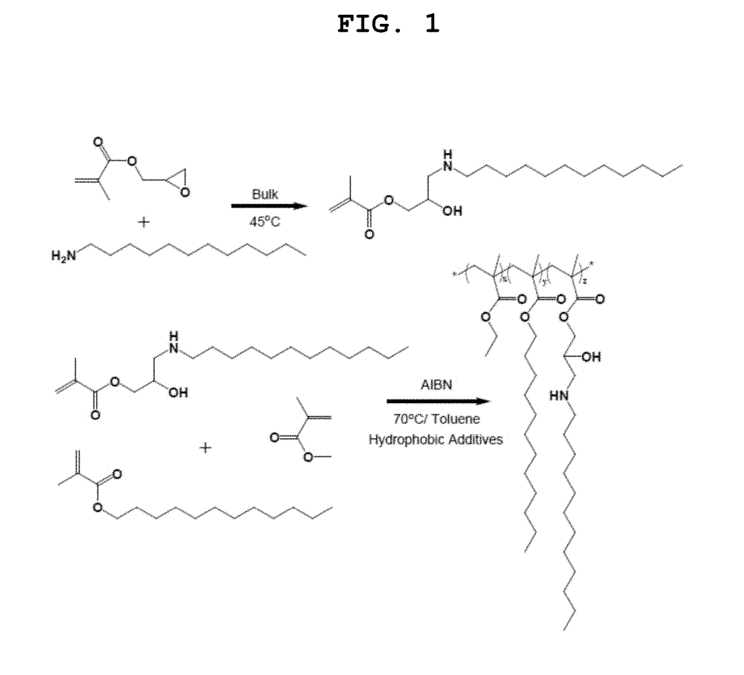

FIG. 2 shows a graphic illustration of the formation of a soft hydrophobic microdomain.

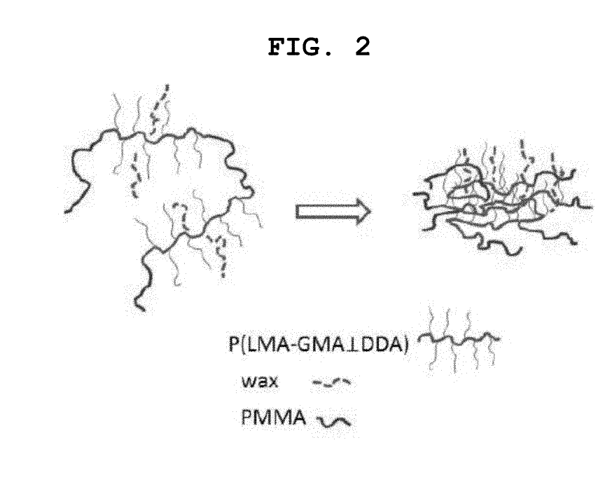

FIG. 3 shows DSC profiles for polymer coating under different paraffin wax loading S1 (0%), S1B (12.8 mol %), S2 (3.2 mol %) and S3 (0.8 mol %).

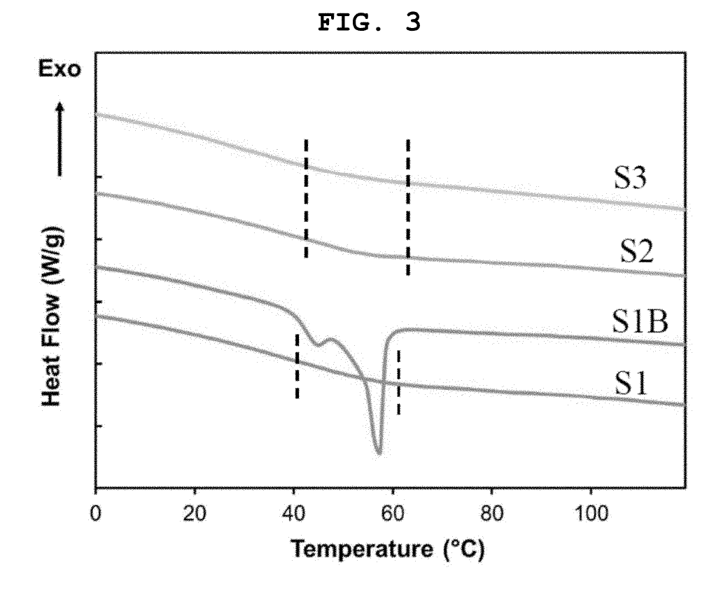

FIG. 4 shows an AFM surface topology characterization phase images of Sample S2 (d) and of Sample S5 with soft domain/rigid boundary microstructure (e).

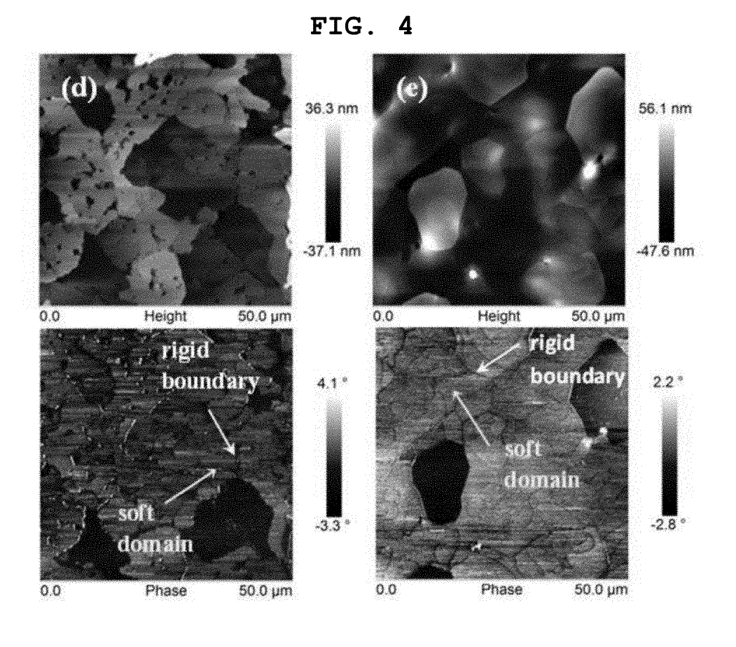

FIG. 5 shows FESEM images of (a) Pristine PU topcoat, (b) PU cast with comb-like copolymer, Sample S1, (c) Coating further modified with 3.2 wt. % paraffin wax, Sample S2, (d) Sample S3, 0.8 wt. % paraffin wax, (e) Sample S4, 1.7 mw. % PE, and (f) Sample S5, 1.7 wt. % PE and 3.2 wt. % paraffin wax.

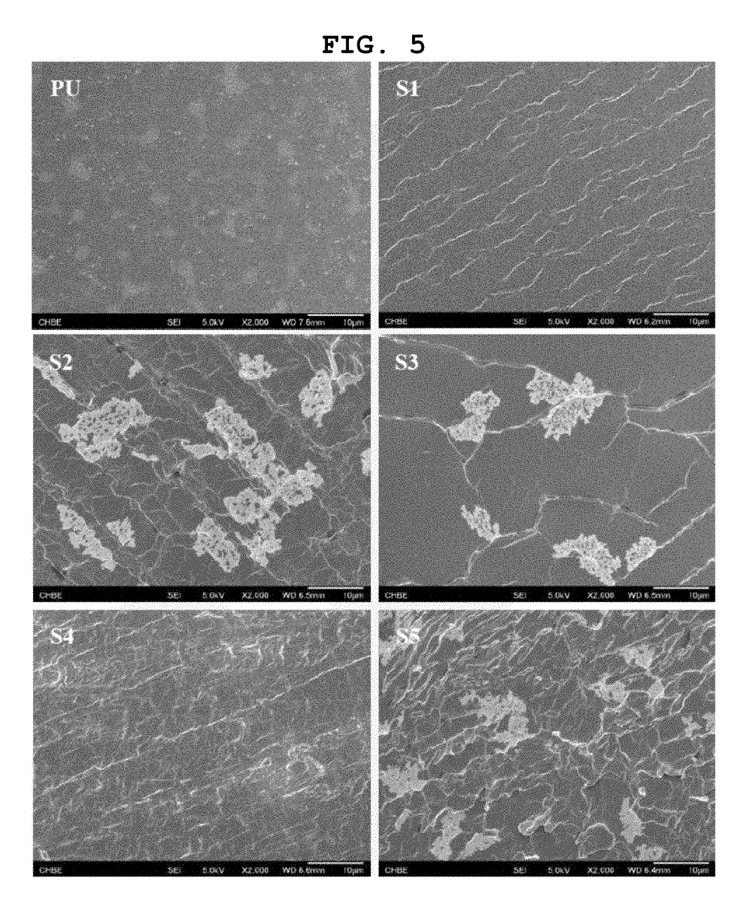

FIG. 6 shows an electron micrograph of sample S2 described in Table 1.

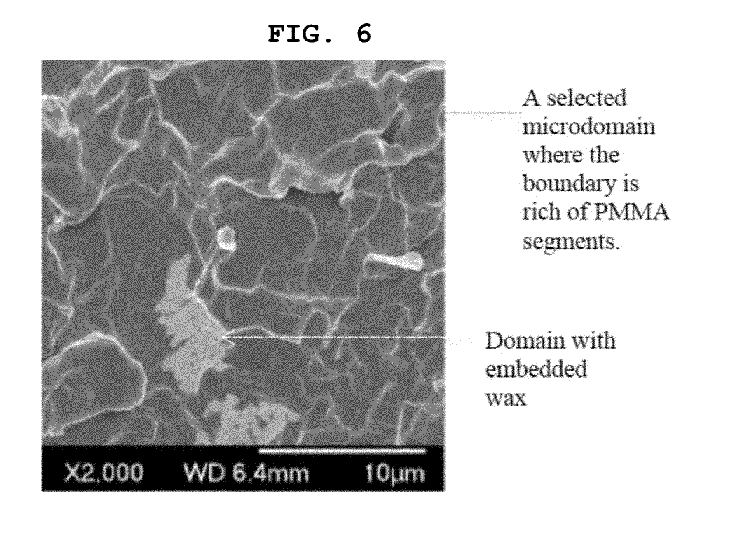

FIG. 7 shows a configuration of a Peltier icing device, the pertinent cooling profile over 30 minutes and visualization of icing over the 4 selected samples at two cooling time points.

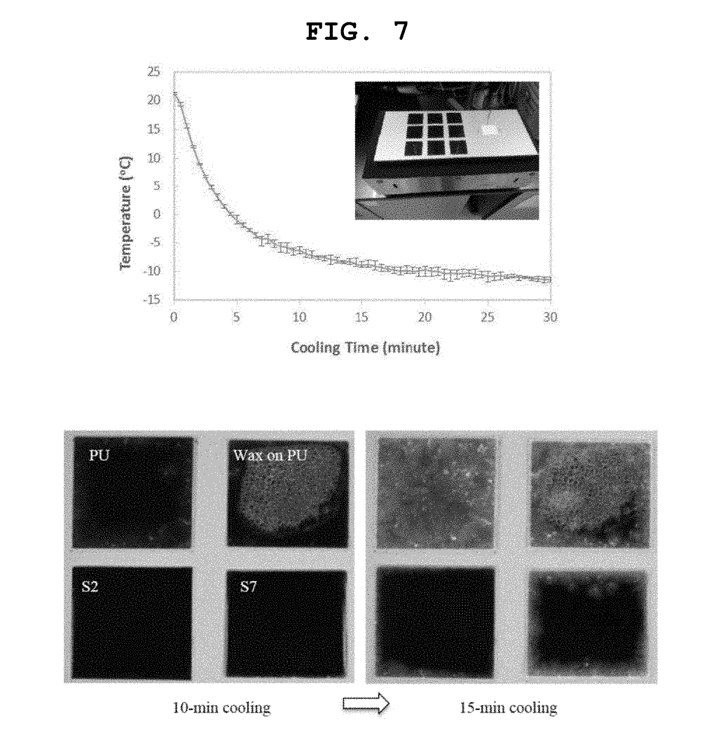

FIG. 8 shows: Top: Microscopic frost formation monitoring on PU topcoat, Scale bar: 500 μm, magnification 50×, and field-of-view dimension of 1.8×2.5 mm, (a-b) visualizing the progress of water condensation at t=2 min (T˜9° C.) and t=5 min (T˜−1° C.), respectively, (c) onset of frost formation at t=8 min (T˜−5.1° C.), (d) spreading of frosting wave front over the entire field-of-view at t=8.5 min (T˜−5.6° C.), and (e-f) subsequent build-up of ice crystals from t=10 to 15 min (T˜−6.3 to −8.9° C.); Bottom: Microscopic frost formation monitoring on IpC S3, Scale bar: 500 μm, magnification 50×, and field-of-view dimension of 1.8×2.5 mm, (a-b) visualizing the progress of water condensation at t=2 min (T˜9° C.) and t=5 min (T˜−1° C.), respectively, (c) onset of frost formation at t=21.7 min (T˜−10.3° C.), (d) spreading of frosting wave front over the entire field-of-view at t=23 min (T˜−10.4° C.), and (e-f) subsequent build-up of ice crystals from t=25 to 30 min (T˜−10.8 to −11.4° C.).

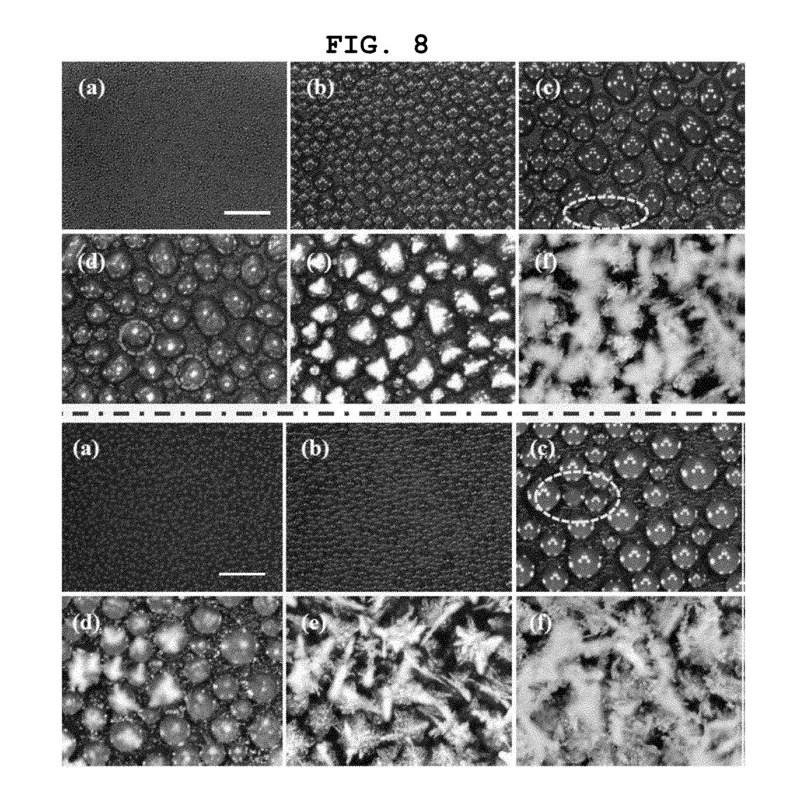

FIG. 9 shows an experimental setup for the determination of the critical shear stress between ice and coating surface, left: Instron 5569 Table Universal testing machine coupled with icing device, right: dissection of icing device metal chamber.

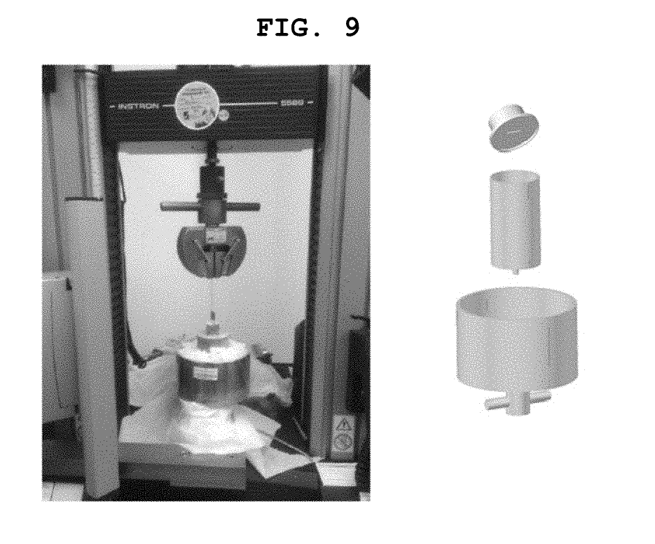

FIG. 10 shows a graphic illustration for the two ice-coating interaction profiles due to different ice adhesions to the surfaces in question.

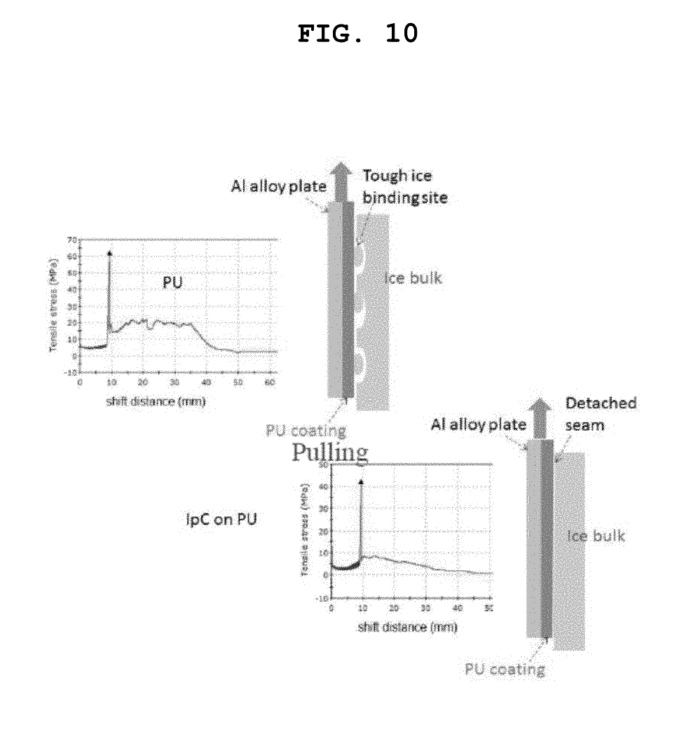

### INDUSTRIAL APPLICABILITY

The inventive segment copolymer can be used in coating solutions to prepare coatings with icephobic capabilities as described above. The coatings can be cured on various substrates, especially metal or other polymer coatings. They can find use in many applications where a coating is desired to render a coated substrate icephobic.

As shown in the examples a special use of the inventive segment copolymer is the use in coatings for aerospace applications. Ice adhesion on critical aircraft surfaces affects aerodynamic control and is a serious hazard. The coatings obtainable are compatible to standard commercial paint systems of aerospace applications. An effective approach to implement ice repellence to a commercial topcoat of aerospace polyurethane (PU, PPG) through covering the PU topcoat with a thin film, which is formed of a segment copolymer, a di-isocyanate curing agent and an appropriately small amount of paraffin wax has already been shown. The achieved reduction is ice adhesion strength may open up numerous new applications. This is especially given as the coatings according to the invention can be prepared according a relatively simple low-cost process. The coatings obtained are colourless and transparent. It can expected that they can be easily adopted in the aerospace industry. The coatings further provide good weatherability (>800 hr in weathering chamber).

It will be apparent that various other modifications and adaptations of the invention are available to the person skilled in the art after reading the foregoing disclosure without departing from the spirit and scope of the invention and it is intended that all such modifications and adaptations come within the scope of the appended claims.

1. A segment copolymer comprising rigid and soft segments wherein the soft segments are doped with a wax.

2. The segment copolymer of claim 1 wherein the rigid segments comprise polymer chains comprising:
monomer units selected from methacrylate, styrene, acrylonitrile butadiene styrene, 4-hydroxylbenzoic acid, vinyl chloride, or
monomers made from bisphenol A (BPA) pre-monomers and the soft segments comprise polymer chains comprising monomer units bearing long aliphatic side chains.

3. The segment copolymer of claim 1 wherein the rigid segment comprises a polymer chain comprising:
monomer units selected from methacrylate, styrene, or 4-hydroxylbenzoic acid and the soft segments comprise a polymer chain comprising:
monomer units bearing a side chain selected from linear or branched C10 (decyl) to C18 (octadecyl) alkyl groups which are optionally substituted and wherein methylene (−CH2-) groups may be optionally replaced by —NH—, —CO—, —C(O)—, —C(O)—NH— or —O— groups.

4. The segment copolymer of claim 1 wherein the polymer chain of the soft segment additionally comprises:
monomers with organic functional groups that can be crosslinked via a crosslinker.

5. The segment copolymer of claim 4 wherein the functional groups are located on side chains close to the main polymer chain of the copolymer.

6. The segment copolymer of claim 4 wherein the functional groups are —NH—, OH, —SH, —NH2, —N3, C3 to C7 alkynyl, or COOH groups.

7. The segment copolymer of claim 1 wherein the monomers of the segment copolymer comprise methyl methacrylate (MMA), lauryl methacrylate (LMA) and an adduct monomer of glycidyl methacrylate (GMA) and 1-dodecylamine (DDA).

8. The segment copolymer of claim 1 wherein the rigid segments substantially consist of polymer chains of methyl methacrylate (MMA) and the rigid segments surround the segregated soft segments which substantially consist of a copolymer of a lauryl methacrylate (LMA) monomer and an adduct monomer of glycidyl methacrylate (GMA) and 1-dodecylamine (DDA).

9. The segment copolymer copolymer of claim 7 wherein the molar ratio of the monomer units LMA:(GMA/DDA) is 1:1 to 1:10 and PMMA:(LMA and (GMA/DDA) is 5:1 to 1:2.

10. The segment copolymer of claim 7 wherein the molar ratio of wax to the combined molar ratios the monomer units of the polymer chains in the soft segments is about 0.6-2.5 mol %.

11. The segment copolymer of claim 1 wherein the wax is selected from linear alkanes, branched alkanes, aromatic or naphthenic substituted alkanes, or glycerides.

12. The segment copolymer of claim 1 wherein the weight ratio of wax to the combined weight ratios the monomer units of the segmented polymer is 0.1 to 10 wt. %.

13. The segment copolymer of claim 1 wherein the overall amount of wax used for the doping is between 4 to 20 mg per g of the copolymer.

14. The segment copolymer of claim 1 which is additionally doped with a polyethylene, polypropylene, perfluoroacrylate, silicone or polyamide oligomer as wax additive wherein the weight ratio of polyethylene oligomer to the wax is about 25 to 55%.

15. A process for making a segment copolymer comprising rigid and soft segments wherein the soft segments are doped with a wax, and wherein the method comprises:
synthesizing the segmented copolymer by reacting the monomers of the soft segment and the rigid segment;
adding wax to the segment copolymer.

16. The process of claim 15 wherein the wax is added during the synthesis of the copolymer.

17. The process of claim 15 wherein in operation (i) the monomers of the rigid and soft segment are polymerized together in a free-radical polymerization and segmentation is achieved by a stronger self-polymerization of the monomers of the rigid segment compared with the copolymerization with the monomers of the soft segment.

18. The process of claim 15 wherein in operation (ii) a polyethylene oligomer is added together with the wax and wherein the weight ratio of polyethylene oligomer to the wax is about 25 to 50%.

19. The process of claim 15 wherein the molar ratio of wax to the combined molar ratios the monomers forming the soft segment is about 0.6 to 2.5 mol %.

20. A polymer coating with hydrophobic microdomains surrounded by rigid segments obtained by curing a coating solution comprising a segment copolymer comprising rigid and soft segments, wherein the soft segments are doped with a wax.
